(19) United States
(12) Patent Application Publication
(10) Pub. No.: US 2003/0126187 A1
(43) Pub. Date: Jul. 3, 2003

(54) Apparatus and method for synchronization in a multi-thread system of JAVA virtual machine

(76) Inventors: Hee Sun Won, Daejeon (KR); Kyeong Deok Moon, Daejeon (KR); Chae Kyu Kim, Daejeon (KR)

Correspondence Address: JACOBSON HOLMAN PLLC, 400 SEVENTH STREET N.W., SUITE 600, WASHINGTON, DC, 20004, US

(21) Appl. No.: 10/178,557

(22) Filed: Jun. 25, 2002

(30) Foreign Application Priority Data
Dec. 28, 2001 (KR) 2001-86930

(51) Int. Cl. G06F 9/00

(52) U.S. Cl. 709/107

(57) ABSTRACT

There is provided an apparatus and a method for synchronization in a multi-thread system of a JAVA virtual machine. The apparatus and the method increase the concurrency of the multi-thread system by subdividing the unit of locking, which is used for implementing thread synchronizing, from object level to object field level. Because the apparatus and the method improve the possibility of sharing an object by subdividing the locking unit for synchronization into field level, the system processing speed can be improved when the apparatus and the method are used as a substructure of the multi-thread system of the JAVA virtual machine or a multi-processor. In addition, because reserved byte-codes in the specification of the JAVA virtual machine are extended, there is no effect on a user of the JAVA virtual machine.

### FIELD OF THE INVENTION

The invention relates to a synchronization technology in a multi-thread system of a JAVA virtual machine; and, more particularly, to an apparatus and a method, which are suitable for subdividing a synchronization unit from object level to object field level, for synchronization in a multi-thread system of a JAVA virtual machine.

### BACKGROUND OF THE INVENTION

In a JAVA virtual machine, an object is associated logically with an individual monitor. In case synchronization is needed for executing codes in a monitor region, variables of the object are protected by using the monitor. In the JAVA virtual machine, the monitor is implemented by using an exclusive lock. Further, only one thread for one object at a time can possess a lock for the object.

In a JAVA program, there is no statement that indicates explicitly a lock for the object. The monitor region is established by using a statement for synchronization or a method for synchronization. The object is locked automatically such that the JAVA virtual machine executes codes in the monitor region.

FIG. 1 exhibits a flow chart showing the performance of an operation in the monitor region in a conventional JAVA virtual machine.

First, in a JAVA monitor region there exists the statement for synchronization and the method for synchronization, and each of the monitor regions is associated with one object.

In step S102, a thread should determine whether it is to execute the beginning of the monitor region, and possess the lock for the object being referred to, to execute the codes in the monitor region(S103).

Because the lock for the object, i.e., an exclusive lock, must be possessed by only one thread at a time, the thread, that requests the lock being used by another thread, remains in a waiting state until it receives a signal indicating that the lock is released(S104).

In this process, a context switch is performed between threads.

Once possessing the lock, the thread can execute the codes of the monitor region(S105, S106), and when the thread quits the monitor region(S107), the possessed lock of the object should be released(S108).

As described above, in the conventional JAVA virtual machine, an object becomes the unit of the locking, such that a monitor requesting access to the part of the object possesses the lock for the object unnecessarily. Accordingly, this makes system efficiency degraded.

Thus, there is needed a method for subdividing the unit of the locking in the JAVA virtual machine, so that the system efficiency can be enhanced in a multi-thread and multi-processor environment.

### SUMMARY OF THE INVENTION

It is, therefore, an object of the present invention to provide an apparatus and a method for synchronization in a multi-thread system of a JAVA virtual machine which can improve a concurrency of the multi-thread system by improving the possibility of sharing an object, enhancing the opportunity of acquiring a lock immediately by a thread and diminishing an unnecessary overhead generated by entering a waiting state, by extending a synchronization instruction set defined in the specification of the JAVA virtual machine using reserved codes with no effect on a user of the JAVA virtual machine and subdividing a unit of locking of the JAVA virtual machine from object level to object field level.

In accordance with one aspect of the present invention, there is provided an apparatus, which subdivides a synchronizing unit from object level to object field level, for synchronization in a multi-thread system of a JAVA virtual machine, the apparatus comprising a lock table associated with each of classes in the JAVA virtual machine; a monitor for referring to information on whether a shared lock and an exclusive lock are available in connection with an object and a lock table of a class which the object belongs to; a lock table instance of the object; a field lock manager for managing the availability of a field lock of the object and-a waiting list of threads.

In accordance with another aspect of the present invention, there is provided a method for synchronization in a multi-thread system of a JAVA virtual machine, the method comprising a first step of decoding an instruction to determine whether it is included at the beginning of a monitor region; a second step of, if the instruction is included in the monitor region, determining whether a thread possess a shared lock of an object; a third step of, if the thread does not possess the shared lock, setting the thread into a waiting state until a lock release signal is received; a fourth step of, if the thread possess the shared lock, determining whether the thread possess a field lock for corresponding entry of a lock table instance, by using index information; a fifth step of, if the thread does not possess the field lock, setting the thread into the waiting state until the lock release signal is received; a sixth step of, if the thread possess the field lock, decoding codes of the monitor region by using the thread.

### BRIEF DESCRIPTION OF THE DRAWINGS

The above and other objects and features of the present invention will become apparent from the following description of preferred embodiments given in conjunction with the accompanying drawings, in which:

FIG. 1 is a flow diagram depicting the execution of codes in a monitor region in a JAVA virtual machine;

FIG. 2A shows a block diagram of an apparatus for synchronization in a multi-thread system of a JAVA virtual machine;

FIG. 2B illustrates a block diagram of the field lock manager of FIG. 2a;

FIG. 3 offers a diagram depicting instructions for synchronization defined by using a reserved byte-code of a JAVA virtual machine specification in accordance with the present invention; and

FIG. 4 is a flow diagram depicting a method for synchronization in a multi-thread system of a JAVA virtual machine according to the preferred embodiment of the present invention.

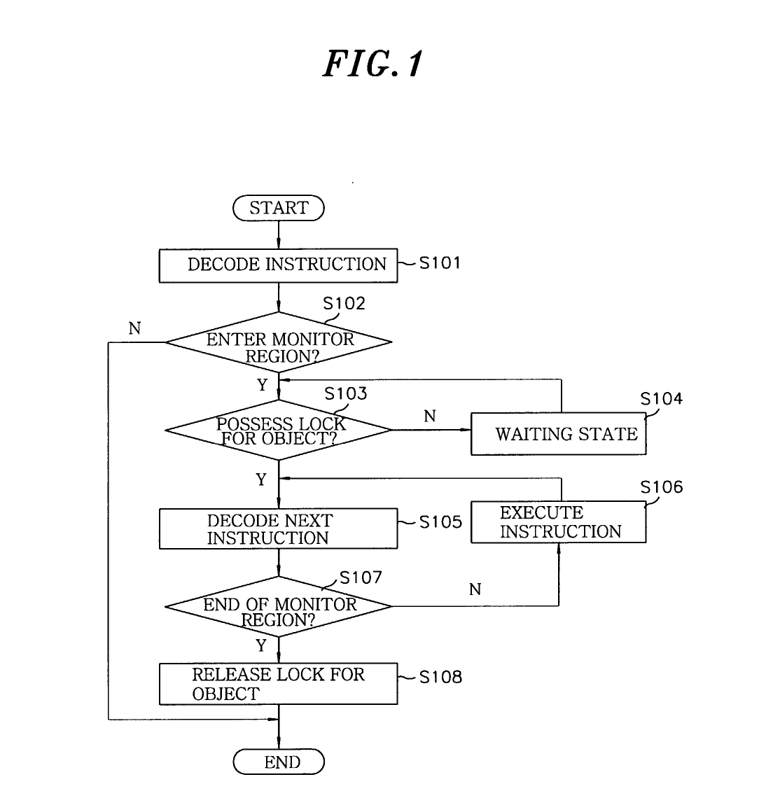

### DETAILED DESCRIPTION OF THE PREFERRED EMBODIMENTS

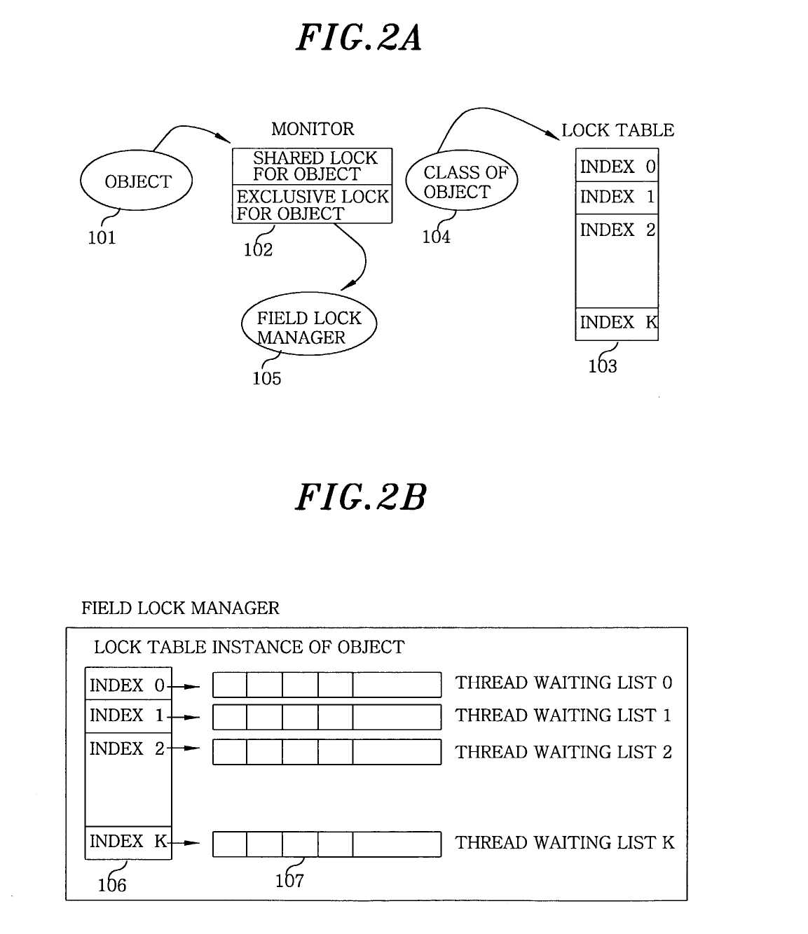

FIG. 2A is a block diagram depicting an apparatus for synchronization in a multi-thread system of a JAVA virtual machine in accordance with the present invention.

Referring to FIG. 2A, a monitor manages a shared lock and an exclusive lock associated with an object 101. The ownership of the object for the shared lock and the exclusive lock is defined as follows.

b 1) In case the shared lock and the exclusive lock are not possessed by any thread, another thread, which calls for the shared lock or the exclusive lock, possesses the lock called for.

2) In case the exclusive lock is possessed by any thread, another thread, which calls for the shared lock or the exclusive lock, enters a waiting state for the lock called for, except the case that the thread possesses the exclusive lock.

3) In case the shared lock is possessed by any thread, another thread, which calls for the shared lock, can possess the shared lock concurrently, but the thread, which calls for the exclusive lock, enters a waiting state for the lock, except the case that the thread possesses the shared lock.

The thread, which possesses the lock of the object, should release all the locks which is acquired at corresponding region after finishing the execution of codes in the monitor region associated with the lock. The exclusive lock of the object is to support the method for synchronization of the conventional JAVA virtual machine. After executing class loader's “verification” step or the initial codes in the monitor region and after replacing the existing byte codes or the information of method structure with the method proposed in the present invention, the shared lock of the object in accordance with the present invention, is used.

If the monitor possesses the shared lock for the object, a field lock, which is a lock for an entry corresponding to the codes of the monitor region to be executed, is selected in the lock table instance of the object. The field lock is an exclusive lock, so that only one thread can possess the field lock at a time, i.e., other threads cannot share the field lock possessed by the thread.

One of methods for configuring the lock table entry is as follows. Because the lock of the fields which are included in the lock table entries are exclusive, each of field groups included in each of lock table entries can be disjoint with respect to each other. Therefore the deadlock generated by executing the lock for each of fields in case it is not composed like this, is prevented. By possessing the lock for the entry of the lock table instance without executing the locking each field, all the field lock needed for the execution of the codes in the monitor region are possessed.

FIG. 2B shows a detailed block diagram of the field lock manager 105 of FIG. 2A explained.

The field lock manager 105 of FIG. 2B manages a class lock table instance of an object. The thread which acquires the shared lock in the above description, can enter the monitor region if it possesses the lock of corresponding entry(the field lock) of the lock table instance accessed to an index associated with the codes in the monitor region to be executed. But if the thread doesn't possess the field lock, it enters a thread waiting list of a corresponding index of the lock table instance, and it is managed by the field lock manager.

In case the corresponding field lock is released, the field lock manager 105 plays a part to continue the execution by transmitting the lock release signal to a waiting thread. In case a number of the waiting thread exists, the field lock manager 105 chooses the thread going to be executed subsequently according to a priority ranking.

A lock table 103 is associated with each of classes defined in the JAVA virtual machine, and has a lock table entry corresponding to each of monitor regions associated with an object 104 of the class, and a lock table entry includes a list of the fields referred to in the corresponding monitor region.

The configuration of the lock table can be made at the suitable part of the next two courses. The first course is a “verification” step of a class file, the second course is after the execution of initial codes in the monitor region. At these step, the JAVA virtual machine can know the information on the fields which need the exclusive lock in the monitor region, so that it can add it by making it the lock table entry corresponding to the monitor region. But, the lock table entries can be disjoint with respect to each other. For example, if a field A and B in the monitor region 1 of any object, a field B and C in the monitor region 2 of any object, a field D and E in the monitor region 3 of any object are referred to, the lock table is composed of two entries, and the entry of index 0 includes the fields A,B,C and the entry of index 1 includes the fields C,D. By configuring it like this, the deadlock that can be generated in case of executing each of field locks, can be prevented, and the field lock management can be done effectively.

Another method for configuring a lock table is that an entry of the lock table is composed of only fields referred to in the monitor region, and furthermore, can be structured to have a list of corresponding entries of other monitor regions which needs to refer to the fields of the monitor region. In this case, in order to acquire a lock of the entry of the lock table instance, it should be checked whether a lock of each of the corresponding entries is being used.

The monitor region is composed of the statement for synchronization and the method for synchronization. In order to apply the present invention to these regions, a procedure that should be processed in each of the monitor regions with the above-mentioned lock table configuration is as follows.

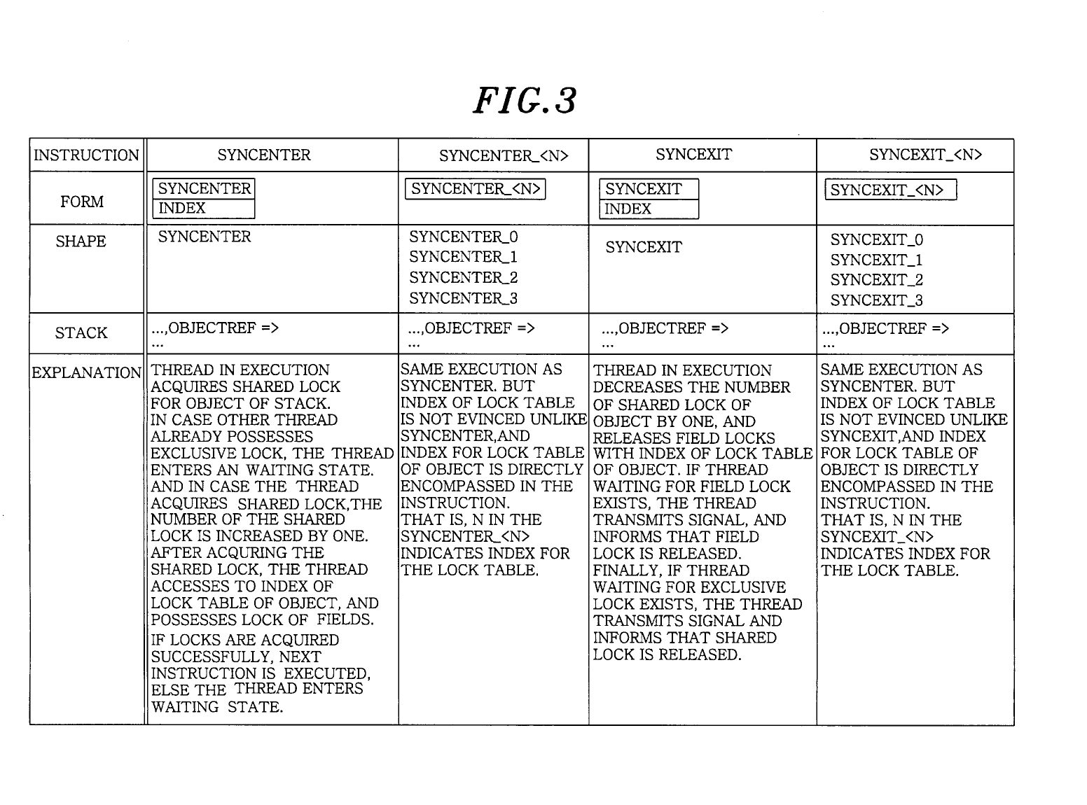

Firstly, in case an entry corresponding to a lock table associated with a class of an object referred to, does not exist, the entry is added. And then, as for the statement for synchronization included in each of instructions, “monitorenter(0xc2)” and “monitorexit(0xc3)”, in the monitor region, the instructions are transformed into instructions, “syncenter” and “syncexit”, respectively, which are shown in FIG. 3. In this case, the index of the lock table entry is stored in an operand. If the index of the lock table entry is the number between 0 and 3, “monitorenter” and “monitorexit” can be transformed into “syncenter_<n>” and “syncexit_<n>”, so that the index operand is not needed separately. The instruction extended in FIG. 3 can use the reserved code or the code(0xfe and 0xff) which depends on embodiment, among byte-codes defined in the specification of the JAVA virtual machine, so that there is no effect on a user of the JAVA virtual machine.

Next, the method for synchronization is approved by using a method qualifier, and the instruction such as “monitorenter” or “monitorexit” is not used. Thus, if it is determined to be the method for synchronization, an inner part of the method is regarded as a region for synchronization. Therefore, in case an entry of a lock table corresponding to this region does not exist, it is newly created, and added to the lock table associated with a class of an object whose method is called for. An index of the lock table entry associated with the method for synchronization is stored with a method data structure managed by the virtual machine.

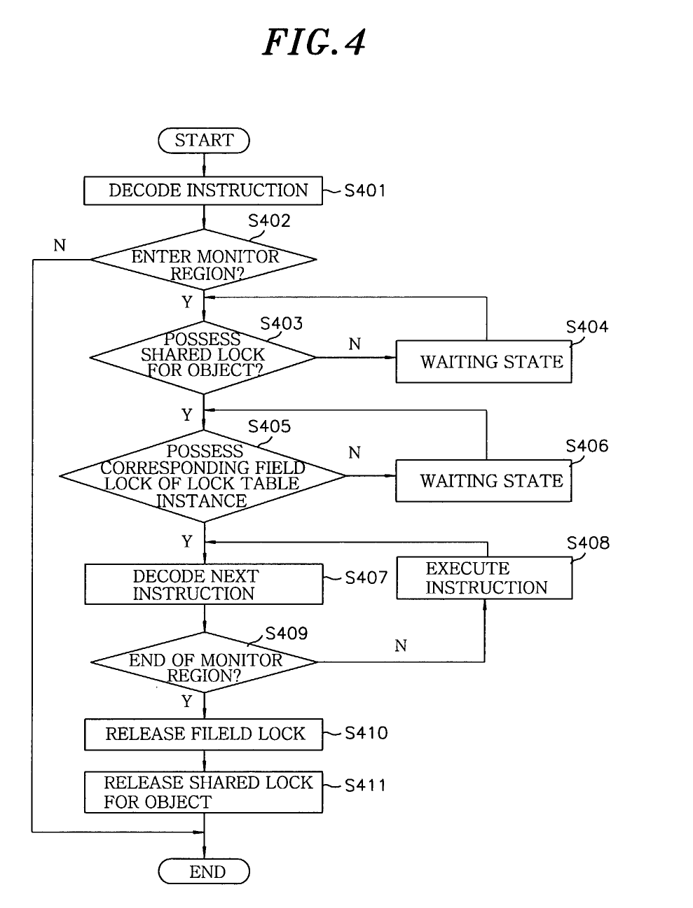

Below, the execution procedure of codes in the monitor region that applies the present invention by referring to FIG. 4 is as follows.

By decoding an instruction, whether it is included at the beginning of the monitor region is determined (S402). In case of the monitor region, the instruction is “syncenter” or “syncenter_<n>”, or the instruction calls for the method for synchronization.

To execute the codes in monitor region, the shared lock of the object referred to is possessed (S403).

In case the shared lock of the object is not possessed, the thread remains in the waiting state until it receives the lock release signal (S404).

The thread that possesses the shared lock executes a field locking to a corresponding entry of the lock table instance by using the index information (S405).

In case the corresponding field lock is not possessed, the thread is set into the waiting state for corresponding field lock, and it remains in the waiting state until it receives the lock release signal from the field lock manager.

The thread that possesses the field lock can execute the codes of monitor region (S407)(S408).

When the thread quits the monitor region by finishing the execution of “syncexit” or “syncexit_<n>” and the method (S409), the thread releases the entry lock of the lock table instance possessed for the execution of the codes in the monitor region at present, that is, the corresponding field lock (S410), and releases the shared lock of the object (S411).

So far, the present invention is explained in detail in accordance with the embodiment, but the present invention is not confined to this type of embodiment, and can be transformed into various types of embodiments in the scope of the keynote.

As explained in the above, according to the present invention, the apparatus and the method which can subdivide the unit of locking of the JAVA virtual machine from object level to object field level is provided, and it is utilized as the substructure of the JAVA virtual machine, so that there is no effect on a user of the JAVA virtual machine, and the concurrency of the multi-thread or multi-processor system can be enhanced.

While the invention has been shown and described with respect to the preferred embodiments, it will be understood by those skilled in the art that various changes and modifications may be made without departing from the spirit and the scope of the invention as defined in the following claims.

What is claimed is:

1. An apparatus, which subdivides a synchronizing unit from object level to object field level, for synchronization in a multi-thread system of a JAVA virtual machine, the apparatus comprising:
a lock table associated with each of classes in the JAVA virtual machine;
a monitor for referring to information on whether a shared lock and an exclusive lock are available in connection with an object and a lock table of a class which the object belongs to;
a lock table instance of the object;
a field lock manager for managing the availability of a field lock of the object and a waiting list of threads.

2. The apparatus of claim 1, wherein the lock table includes entries having fields referred to in a monitor region which the object of the class belongs to, wherein each of field groups included in each of entries is disjoint with respect to each other.

3. The apparatus of claim 1, wherein the field lock manager includes:
a means, which is associated with the object, for managing the lock table instance of the class, and inserting into an waiting list of corresponding entry a thread which fails in obtaining a field lock;
a means for, when the field lock is released, transmitting a lock release signal to the thread in the waiting list of the entry in which the released field is included.

4. A method for synchronization in a multi-thread system of a JAVA virtual machine, the method comprising:
a first step of decoding an instruction to determine whether it is included at the beginning of a monitor region;
a second step of, if the instruction is included in the monitor region, determining whether a thread possesses a shared lock of an object;
a third step of, if the thread does not possess the shared lock, setting the thread into a waiting state until a lock release signal is received;
a fourth step of, if the thread possesses the shared lock, determining whether the thread possesses a field lock for corresponding entry of a lock table instance, by using index information;
a fifth step of, if the thread does not possess the field lock, setting the thread into the waiting state until the lock release signal is received;
a sixth step of, if the thread possesses the field lock, decoding codes of the monitor region by using the thread.

5. The method of claim 4, wherein the method further includes a step of, after the sixth step, releasing corresponding field lock of the lock table instance, the field lock being possessed by the thread for the execution of the monitor region, and releasing the shared lock of the object.

6. The method of claim 4, wherein the instruction included in the monitor region is “syncenter or “syncenter_<n>”, or calls for a method for synchronization.
